(19) United States
(12) Patent Application Publication
(10) Pub. No.: US 2015/0189060 A1
(43) Pub. Date: Jul. 2, 2015

(54) CASE FOR PORTABLE ELECTRONIC DEVICE AND CONNECTING METHOD THEREOF

(71) Applicant: FIH (HONG KONG) LIMITED, Kowloon (HK)

(72) Inventor: YUNG-SUNG PENG, New Taipei (TW)

(21) Appl. No.: 14/556,633

(22) Filed: Dec. 1, 2014

(30) Foreign Application Priority Data
Dec. 31, 2013 (TW) 102149183

(51) Int. Cl. H04M 1/725

(52) U.S. Cl. CPC H04M 1/7253

(57) ABSTRACT

A case includes a main body, a storage module, a connector, a Wi-Fi Direct module, and a Bluetooth® module. The main body is coupled to a portable electronic device. The connector is extended from the main body and is connected to a data transmitting connector of the portable electronic device. The Wi-Fi Direct module is wirelessly connected to the portable electronic device. The Bluetooth® module is connected to the portable electronic device via Bluetooth®. The connector, the Wi-Fi Direct module, or the Bluetooth® module selectively connects to the portable electronic device, thereby establishing communication with the storage module to enlarge a storage capacity. A connecting method of the case and the portable electronic device is also provided.

### FIELD

The subject matter herein generally relates to a case for portable electronic device, and particularly relates to a case having storage utility and connecting method with a portable electronic device.

### BACKGROUND

Portable electronic devices, such as smart phones, installing a storage module or a connector to connect an external storage card, so as to storage data for the portable electronic device. Due to a capability of the storage module is limited that may not meet a high data amount requirement. In addition, when the portable electronic device adds an external storage card, which may occupies great internal space of the portable electronic device. There is a case coupled to the portable electronic device to protect the portable electronic device. However, it's a simplex function of the case. Therefore there is still improvement in the art that the case can have multiple functions including increasing a storage capability for the portable electronic device.

### BRIEF DESCRIPTION OF THE DRAWINGS

Many aspects of the disclosure can be better understood with reference to the following figures. The components in the figures are not necessarily drawn to scale, the emphasis instead being placed upon clearly illustrating the principles of the disclosure. Moreover, in the drawings, like reference numerals designate corresponding parts throughout the several views.

FIG. 1 is an isometric view of an exemplary embodiment of a case for a portable electronic device.

FIG. 2 is an isometric view of the case including a plurality of modules.

FIG. 3 is a block diagram of an exemplary embodiment of the modules of the case.

FIG. 4 is a flowchart of a method of connecting the case connecting to a portable electronic device.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series and the like.

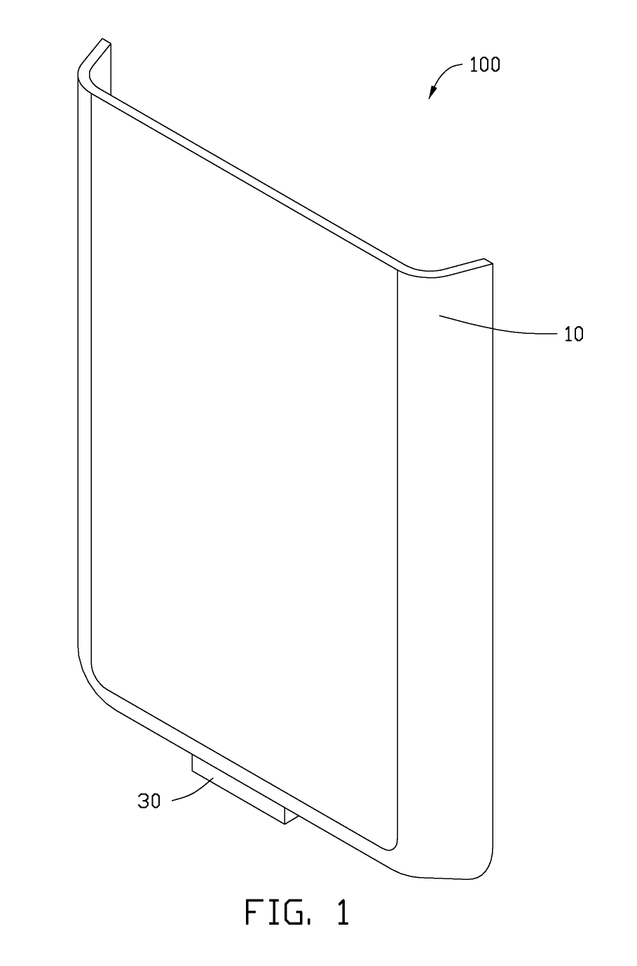

FIG. 1 illustrates at least one embodiment of a case 100 coupling to a portable electronic device. The portable electronic device can be a smart phone or a tablet computer.

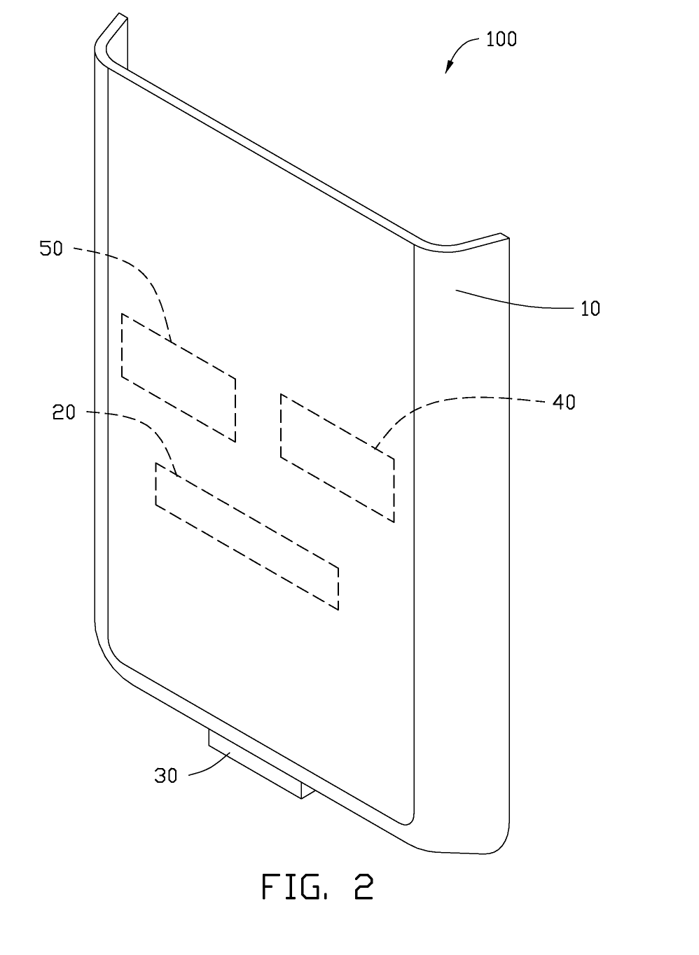

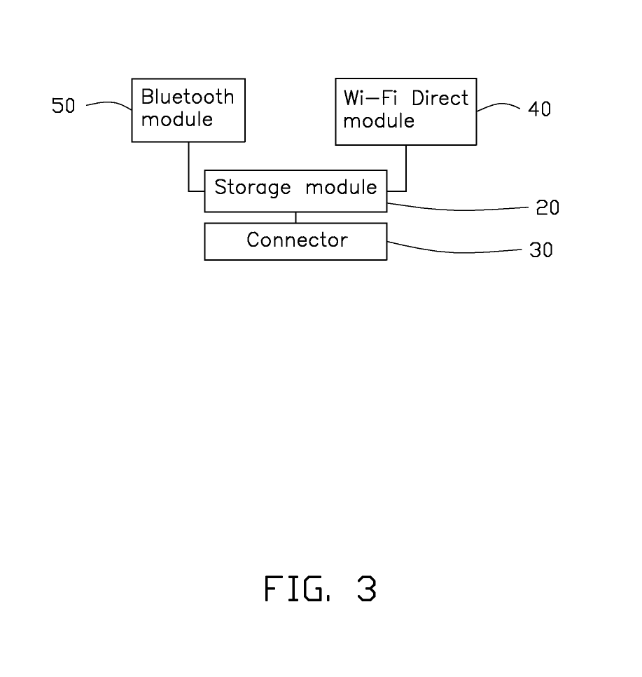

Referring to FIGS. 2 and 3, the case 100 includes a main body 10, a storage module 20, a connector 30, a Wi-Fi Direct module 40, and a Bluetooth® module 50.

The main body 10 is coupled to the portable electronic device, which is for protecting the portable electronic device. In at least one embodiment, the main body 10 has a predetermined thickness.

The storage module 20 is arranged in the main body 10. In at least one embodiment, the storage module 20 has a predetermined thickness, which is smaller than the thickness of the main body 10. The storage module 20 is electrically connected to the connector 30, the Wi-Fi Direct module 40, and the Bluetooth® module 50. The storage module 20 can establish communication to the portable electronic device via one of the connector 30, the Wi-Fi Direct module 40, and the Bluetooth® module 50. The storage module 20 has a predetermined storage capacity. When the storage module 20 establishes communication with the portable electronic device, the storage module 20 can be external storage device which can store, transmit, and exchange data with the portable electronic device.

The connector 30 is electrically connected to the storage module 20 and extends from the main body 10, thereby physically and electrically connecting to a data transmitting connector. The connector 30 is adapted to a data cable connection to the portable electronic device. For example, a micro USB connector for Android® system or a dock connector for iOS system. The storage module 20 can establish communication with the portable electronic device via the connector 30 connecting to the data transmitting connector of the portable electronic device.

The Wi-Fi Direct module 40 is arranged in the main body 10 and has a smaller thickness than the main body 10. The Wi-Fi Direct module 40 is used for wirelessly connecting the storage module 20 to the portable electronic device. In at least one embodiment, the Wi-Fi Direct module 40 is wirelessly connected to the portable electronic device one-on-one. The portable electronic device can set a connection management to search a Wi-Fi connection, thereby searching the Wi-Fi Direct module 40 to establish a Wi-Fi connection. After the Wi-Fi connection is established, the portable electronic device can access the storage module 20 and exchange data with the storage module 20.

The Bluetooth® module 50 is arranged in the main body 10 and has a smaller thickness than the main body 10. The Bluetooth® module 50 is used for the storage module 20 connecting to the portable electronic device via Bluetooth® matching. The portable electronic device can set a connection management to search a Bluetooth® connection, thereby searching the Bluetooth® module 50 to establish a Bluetooth® connection. After the Bluetooth® connection is established, the portable electronic device can access the storage module 20 and exchange data with the storage module 20.

The storage module 20 can establish communication with the portable electronic device via one of the connector 30, the Wi-Fi Direct module 40, or the Bluetooth® module 50. In at least one embodiment, the portable electronic device may include a management application for managing the connection options to the case 100. By selecting the options, the portable electronic device selectively opens or closes the Wi-Fi or Bluetooth®.

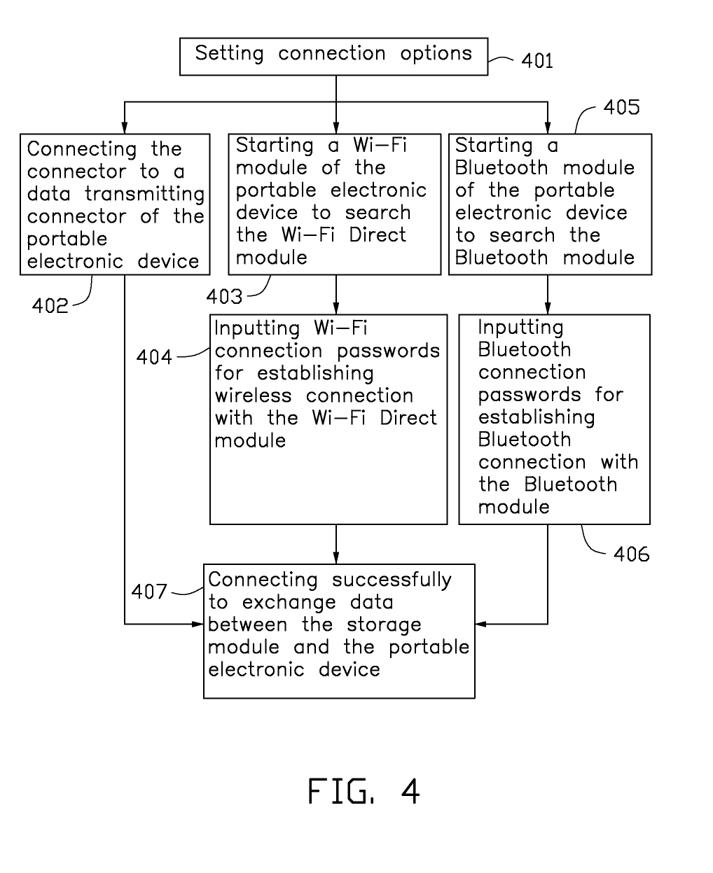

Referring to FIG. 4, a flowchart is presented in accordance with an example embodiment which is being thus illustrated. The example a method of connecting the case 100 and the portable electronic device described below can be carried out using the configurations illustrated in FIGS. 1, 2, and 3, for example, and various elements of these figures are referenced in explaining example method. Each block shown in FIG. 4 represents one or more processes, methods or subroutines, carried out in the exemplary method. Furthermore, the illustrated order of blocks is by example only and the order of the blocks can change according to the present disclosure. Additional blocks may be added or fewer blocks may be utilized, without departing from this disclosure. The exemplary method can begin at block 401.

At block 401, connection options are set. The portable electronic device establishes communication with the storage module 20 via one of the connector 30, the Wi-Fi Direct module 40, or the Bluetooth module 50. When the connector 30 is selected, the method goes to block 402; when the Wi-Fi Direct module 40 is selected, the method goes to block 403; when the Bluetooth® module 50 is selected, the method goes to block 404.

At block 402, the connector 30 is connected to a data transmitting connector of the portable electronic device.

At block 403, a Wi-Fi unit of the portable electronic device is started to search the Wi-Fi Direct module 40. When the Wi-Fi Direct module 40 is found, the method goes to block 404; when the Wi-Fi Direct module 40 is not found, the method returns back and restarts block 403.

At block 404, Wi-Fi connection passwords are input for establishing wireless connection with the Wi-Fi Direct module 40.

At block 405, a Bluetooth® unit of the portable electronic device is started to search the Bluetooth® module 50. When the Bluetooth® module 50 is found, the method goes to block 406; when the Bluetooth® module 50 is not found, the method returns back and restarts block 405.

At block 406, Bluetooth® connection passwords are input for establishing Bluetooth® connection with the Bluetooth® module 50.

At block 407, connection is made to exchange data between the storage module 20 and the portable electronic device.

The case 100 can protect the portable electronic device and further enlarge the storage ability of the portable electronic device by arranging the storage module 20 in the case 100. In addition, the storage module 20 can be connected to the portable electronic device via multiple ways, which is very convenient for being used.

It is believed that the embodiments and their advantages will be understood from the foregoing description, and it will be apparent that various changes may be made thereto without departing from the scope of the disclosure or sacrificing all of its advantages, the examples hereinbefore described merely being illustrative embodiments of the disclosure.

What is claimed is:

1. A case for a portable electronic device, the portable electronic device including a data transmitting connector, the case comprising:
a main body configured for coupling to the portable electronic device;
a storage module;
a connector extending from the main body and connecting to the data transmitting connector of the portable electronic device;
a Wi-Fi Direct module wirelessly connecting to the portable electronic device; and
a Bluetooth module connecting to the portable electronic device via Bluetooth;
wherein the storage module, the Wi-Fi Direct module, and the Bluetooth module are arranged in the main body; the storage module is electrically connected to the connector, the Wi-Fi Direct module, and the Bluetooth module; and the connector, the Wi-Fi Direct module, or the Bluetooth module selectively connects to the portable electronic device, thereby establishing communication with the storage module to enlarge a storage capacity.

2. The case as claimed in claim 1, wherein the case has a predetermined thickness, the storage module, the Wi-Fi Direct module, and the Bluetooth module have a smaller thickness than the case.

3. The case as claimed in claim 1, wherein the connector is adapted to a data cable connection to the portable electronic device.

4. The case as claimed in claim 1, wherein the portable electronic device wirelessly searches the Wi-Fi Direct module and establishes wireless communication with the Wi-Fi Direct module, thereby wirelessly accessing the storage module.

5. The case as claimed in claim 1, wherein the portable electronic device searches the Bluetooth module via a Bluetooth unit of the portable electronic device, and then establishes Bluetooth communication with the Bluetooth module, thereby accessing the storage module via Bluetooth.

6. The case as claimed in claim 1, wherein when the portable electronic device establishes communication with the storage module, the portable electronic device accesses the storage module and further stores, transmits, and exchanges data with the storage module.

7. The case as claimed in claim 1, wherein the portable electronic device includes a management application for managing the connection options to the case, by selecting the options, the portable electronic device selectively opens or closes the Wi-Fi or Bluetooth connection.

8. A method of connecting a case and a portable electronic device, the method comprising:
setting connection options of the case connecting to the portable electronic device;
selecting a connector connection and connecting a connector to a data transmitting connector of the portable electronic device;
selecting a wireless connection and searching a Wi-Fi Direct module to establish a wireless connection; and
selecting a Bluetooth connection and searching a Bluetooth module to establish a Bluetooth connection.

9. The method as claimed in claim 8, wherein when the portable electronic device establishes communication with the storage module, the portable electronic device accesses the storage module and further stores, transmits, and exchanges data with the storage module.

10. The method as claimed in claim 8, further comprising starting a Wi-Fi unit of the portable electronic device to search the Wi-Fi Direct module.

11. The method as claimed in claim 10, further comprising inputting Wi-Fi connection passwords for establishing wireless connection with the Wi-Fi Direct module.

12. The method as claimed in claim 8, further comprising starting a Bluetooth unit of the portable electronic device to search the Bluetooth module.

13. The method as claimed in claim 12, further comprising inputting Bluetooth connection passwords for establishing the Bluetooth connection with the Bluetooth module.
